(19) United States
(12) Patent Application Publication
(10) Pub. No.: US 2026/0143270 A1
(43) Pub. Date: May 21, 2026

(54) DYNAMIC SOUND OUTPUT ADJUSTMENT BASED ON ENVIRONMENTAL DETECTION

(71) Applicant: ROKU, INC., San Jose, CA (US)

(72) Inventors: Hsuan-Hao HSU, Taoyuan (TW); Hsiang-Yao Shih, Hsinchu (TW)

(73) Assignee: ROKU, INC., San Jose, CA (US)

(21) Appl. No.: 18/949,332

(22) Filed: Nov. 15, 2024

(51) Int. Cl. H04R 1/02; H04R 1/20

(52) U.S. Cl. CPC H04R 1/028; H04R 1/20

(57) ABSTRACT

Disclosed herein are system, apparatus, article of manufacture, method and/or computer program product embodiments, and/or combinations and sub-combinations thereof, for dynamically adjusting sound output of a multi-speaker configuration of a display device. The adjustment may be performed to optimize the sound output based on the physical position of the display device in relation to one or more microphones within a physical environment. An example embodiment operates by the speakers within the display device emitting calibration sound waves and receiving sound data associated with the calibration sound waves. The sound data includes characteristics of the calibration sound waves within the physical environment. The display device may then adjust sound output of speakers within the multi-speaker configuration based on the sound output characteristics.

### BACKGROUND

### Field

This disclosure is generally directed to dynamically calibrating and optimizing sound output of media devices such as external sound devices and televisions.

### Background

In the context of media systems, directing sound output from media devices like display devices (e.g., televisions) and external media devices (e.g., sound bars, external speakers) poses a significant challenge due to the variety of physical environments in which these devices are positioned. Each household presents a unique set of variables, such as room size, distances from walls, the presence of objects, and other factors that can affect sound quality. This variability means there is no one-size-fits-all solution for achieving optimal sound output. Traditional audio playback configurations, including home entertainment systems, radio, and television sets, often lack the capability to automatically tailor their acoustic properties to suit different environments.

Typically, users must manually intervene to adjust settings—whether by tweaking equalizers, selecting from predefined profiles, or repositioning physical speakers. These manual adjustments require time, knowledge, and effort to achieve the desired sound quality. Moreover, even when adjustments are made for one setup, they might need to be altered again for different content or varying playback conditions. While surround sound and sound reinforcement systems can provide some level of adaptability through passive filters and fixed rules, they often fall short in enhancing sound quality across diverse audio content. As a result, even professionally installed audio systems configured by acoustical engineers face limitations, requiring either highly specialized settings or compromises for broader use. The challenge lies in developing a solution that can dynamically and appropriately direct sound output across different physical environments, ensuring an optimal listening experience regardless of a room's unique physical characteristics.

### SUMMARY

Disclosed herein are system, apparatus, device, method, and computer-readable storage medium embodiments for dynamically adjusting sound output in media devices having multiple speaker configurations, such as a television. In some embodiments, the media device may include a television connected to an external media device, such as a set-top box. In some embodiments, the media device includes side-firing speakers. In some embodiments, the media device may include side-firing speakers in addition to speakers positioned on the bottom and behind the screen to optimize sound output based on the content and the physical environment.

In some embodiments, a method for dynamically adjusting the sound output of a multi-speaker configuration of a media device, such as a display device or external media device, comprises steps for detecting an initiation event for initiating the dynamic adjustment of sound output of the multi-speaker configuration and causing a first speaker of the multi-speaker configuration to emit a first calibration sound wave and a second speaker of the multi-speaker configuration to emit a second calibration sound wave responsive to detecting the initiation event. Additional steps can include receiving, from a remote device, sound data, wherein the sound data comprises a sound output characteristic associated with the first calibration sound wave and the second calibration sound wave, analyzing the sound data based on a sound characteristic threshold value, and adjusting sound output of at least one of the first speaker and the second speaker based on the sound output characteristic.

The sound adjustments generated during the dynamic sound adjustment may comprise adjustments to different audio settings of the sound output from each speaker of the display device. For instance, one audio setting might adjust output of the side-firing speakers to enhance spatial audio effects, while another setting might adjust the bottom or rear speakers to provide a more immersive bass response or to direct dialogue more effectively towards the listener. The system intelligently assigns audio settings to specific speakers, taking into account their positions—side-firing, bottom, or rear—to create an optimal sound profile tailored to the current physical environment.

By dynamically adjusting sound settings using speakers out with varied orientations on a television, such as side-firing, bottom, and rear speakers, the dynamic sound adjustment procedure can dynamically adapt sound output to suit dynamically detected room acoustics. This approach ensures an improved audio experience regardless of the television's placement within the room, overcoming the limitations of traditional fixed speaker setups.

### BRIEF DESCRIPTION OF THE FIGURES

The accompanying drawings are incorporated herein and form a part of the specification.

FIG. 1 is a block diagram of a multimedia environment, according to some embodiments.

FIG. 2 is a block diagram of a streaming media device, according to some embodiments.

FIG. 3 is a block diagram of a display device, according to some embodiments.

FIGS. 4A-4B are diagrams illustrating example implementations of a media device in an exemplary physical environment, according to some embodiments.

FIG. 5 is a flowchart illustrating a method for initiating a dynamic sound adjustment procedure, according to some embodiments.

FIG. 6 is a flowchart illustrating a method for calibrating speaker output, according to some embodiments.

FIG. 7 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer-readable storage-medium embodiments, and/or combinations and sub-combinations thereof, for dynamically adjusting sound output from a multiple speaker configuration of a media device. The adjustment of the sound output results in optimized sound delivery from each speaker of the media device based on the specific physical characteristics of the environment in which the media device is position. In some embodiments, the adjustment of the sound output may also be based on a user position in relation to the media device within the environment.

The present disclosure describes embodiments for solving the technical problem of uneven or unbalanced sound output by display and media devices that is caused by uneven or asymmetric physical environment. The embodiments describe providing dynamically calibrating sound delivery of a media device, and in particular, a media device that is implemented with a multiple speaker configuration where at least a plurality of the speakers of the speaker configuration are internal (e.g., internal television woofer or speakers) or connected (e.g., sound bar) to the media device. An example of such a media device is a television with at least a plurality of side-firing speakers (e.g., a left side-firing speaker and a right side-firing speaker). Speakers of media device can be implemented as any directionally oriented speakers, such as any front-firing, down-firing, up-firing, or side-firing speakers.

The present disclosure describes a technical solution this problem that allows for dynamic calibration of sound delivery of a media device such that sound output from the media device is optimized for the particular characteristics of the physical environment and a position of the viewer. An example of optimization include balancing sound output asymmetry providing enhanced sound output at a particular location within the physical environment. Examples of characteristics include structures that can impede soundwaves (e.g., walls, objects placed within the environment) and reflect soundwaves (e.g., walls).

The technical solution includes steps for utilizing sound diagnostic waves emitted from each of the speakers of the media device, receiving sound data associated with the sound diagnostic waves from a remote device, and utilizing the sound data for adjusting the sound characteristics of each of the speakers of the media device. Examples of sound data include sound intensity (amplitude) information, frequency, waveform characteristics which reflect a shape of the sound wave over time, phase information, time information, harmonic content, and dynamic range for each of the sound diagnostic waves. Examples of adjustments include increasing or decreasing the sound characteristics including the bass and treble, equalizer (EQ) settings, sound balance, activating sound modes (e.g., dialogue, cinema, game), and dynamic range.

The media device can repeat the adjustment procedure after each adjustment until the modified sound characteristics of each speaker is optimized for the environment. In some embodiments, adjustment procedure includes a step for confirming that the modified sound characteristics meets a sound characteristic threshold, and the adjustment procedure may repeat if the characteristics fail to meet the threshold. In some embodiments, the media device may initiate the adjustment procedure based on an initiation event which includes a scheduled adjustment check (e.g., every day, every week), upon user request, or upon turning on the media device.

In some embodiments, the remote device comprises one or more microphones for receiving the sound diagnostic waves. The remote device may detect sound characteristics of the received sound diagnostic waves and generate sound data based on the detected sound characteristics. For example, the sound data may comprise the detected sound characteristics of each received sound diagnostic wave. In some embodiments, the remote device may be configured to associate the detected sound characteristics of each sound diagnostic wave with the speaker of the multi-speaker configuration of the media device.

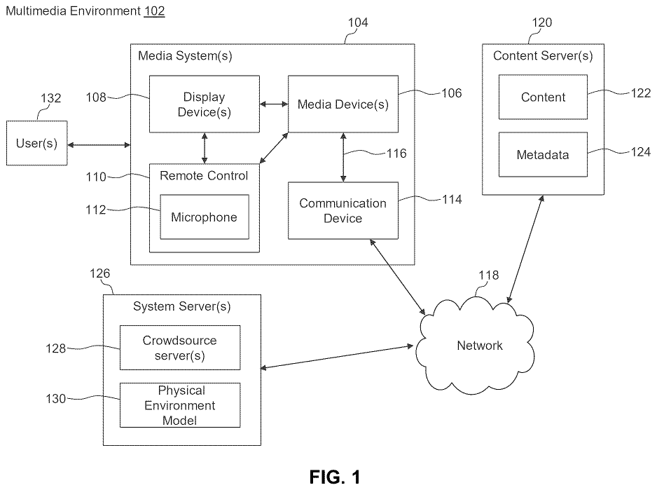

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102 including a media system 104 for implementing a dynamic sound adjustment procedure, according to some embodiments. Multimedia environment 102 illustrates an example environment, architecture, ecosystem, etc., in which various embodiments of this disclosure may be implemented. However, multimedia environment 102 is provided solely for illustrative purposes, and is not limiting. Embodiments of this disclosure may be implemented and/or used in environments different from and/or in addition to multimedia environment 102 of FIG. 1, as will be appreciated by persons skilled in the relevant art(s) based on the teachings contained herein.

The multimedia environment 102 may include one or more media systems 104. A media system 104 comprises many devices and can be implemented within a single location, or in distributed locations, such as in one or more of a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. For example, there may be one or more display devices 108 of media system 104 with each display device 108 being located in a separate location. User(s) 132 may operate the media system 104 to select and view content, such as content 122.

Each media system 104 may include one or more media device(s) 106 each coupled to one or more display device(s) 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, a streaming set-top box (STB), cable and satellite STB, a DVD or BLU-RAY device, an audio/video playback device, a cable box, and/or a digital video recording device, to name just a few examples. Display device 108 may be a monitor, a television (TV), a computer, a computer monitor, a smart phone, a tablet, a wearable (such as a watch or glasses), an appliance, an internet of things (IoT) device, and/or a projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections. In some embodiments, communication device 114 can be a part of, integrated with, operatively coupled to, and/or connected to a respective media device 106 and/or a respective display device 108.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below. When implemented as a smartphone or tablet, operations of the remote control 110 may be provided by a software program installed on the smartphone or tablet that provide a user interface that includes controls of the remote control 110.

The multimedia environment 102 may include a plurality of content server(s) 120 (also called content providers, channels, or sources). Although only one content server 120 is shown in FIG. 1, in practice the multimedia environment 102 may include any number of content server(s) 120. Each content server 120 may be configured to communicate with network 118. Each content server 120 may be configured to communicate with network 118. Content server 120, media device 106, display device 108, may be collectively referred to as a media device, which may be an extension of media system 104. In some embodiments, a media device may include system server 126 as well.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form. Content 122 may be the source displayed on display device 108.

Examples of content 122 include electronic representations of video, audio, text, graphics, or the like which may be but is not limited to electronic representations of videos, movies, or other multimedia, which may be but is not limited to data files adhering to MPEG2, MPEG, MPEG4 UHD, HDR, 4k, Adobe® Flash® Video (. FLV) format or some other video file format whether the format is presently known or developed in the future. The content items described herein may be electronic representations of music, spoken words, or other audio, which may be but is not limited to data files adhering to the MPEG1 Audio Layer 3 (. MP3) format, Adobe®, CableLabs 1.0,1.1, 3.0, AVC, HEVC, H.264, Nielsen watermarks, V-chip data and Secondary Audio Programs (SAP), Sound Document (. ASND) format, or some other format configured to store electronic audio whether the format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (. PSD) format or some other format for electronically storing text, graphics and/or other information whether the format is presently known or developed in the future. Content items may be any combination of the above-described formats.

As used in the specification, “content items” may also be referred to as “content,” “content data,” “content information,” “content asset,” “multimedia asset data file,” or simply “data” or “information”. Content items may be any information or data that may be licensed to one or more individuals (or other entities, such as businesses or groups).

In some embodiments, metadata 124 comprises data about content 122. For example, metadata 124 may include closed captioning data, such as text data, associated with content 122. Metadata 124 may further include timeslots that link the closed captioning data to the audio data of content 122. The timeslots allow the display of the closed captioning data by display device 108 to be synced with the playback of audio data of content 122 such that the text provided by the closed captioning data matches the timeslot when the audio data is played such as by display device 108 or another sound playback device.

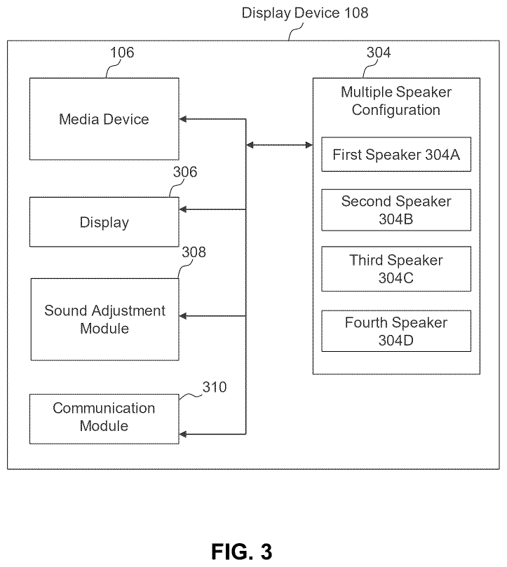

Metadata 124 may further include indicating or related to labels of the materials in the content 122, writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index. In some embodiments, content 122 can include a plurality of content items, and each content item can include a plurality of frames having metadata about the corresponding frame (see FIG. 3).

The multimedia environment 102 may include one or more system server(s) 126. The system server(s) 126 may operate to support the media device(s) 106 from the cloud. It is noted that the structural and functional aspects of the system server(s) 126 may wholly or partially exist in the same or different ones of the system server(s) 126. System server(s) 126 and content server 120 together may be referred to as a media server system. An overall media device may include a media server system and media system 104. In some embodiments, a media device may refer to the overall media device including the media server system and media system 104.

The media device(s) 106 may exist in thousands or millions of media systems 104. Accordingly, the media device(s) 106 may lend themselves to crowdsourcing and machine learning embodiments and, thus, the system server(s) 126 may include one or more crowdsource servers 128 and physical environment model 130.

For example, using information received from the media device(s) 106 in the thousands and millions of media systems 104, the crowdsource server(s) 128 may identify similarities and overlaps between sound data received by one or more media devices 106 that is provided during the dynamic sound adjustment process that is performed at respective media system(s) 104. Based on such information, the crowdsource server(s) 128 may identify patterns in the sound characteristics (e.g., sound intensity, frequency, waveforms, phase, time information, harmonic content, and dynamic range) and the sound adjustments made for respective speakers of the display device(s) 108 and/or media device(s) 106 (e.g., such as increasing or decreasing the volume, adjusting bass and treble, adjusting equalizer settings, adjusting balance between speakers, selecting an appropriate sound mode, and adjusting dynamic range between speakers). Media systems 104 may provide the sound characteristics and the sound adjustments that were made based on the sound characteristics. The sound adjustments may include all sound adjustments that were made as part of the iterative dynamic adjustment process, or the final sound adjustments that were selected (i.e., that met the threshold requirements). Based on these identified patterns, crowdsource server(s) may generate profiles or suggestions with predefined settings based on detected sound characteristics of the calibration sound waves, which can be downloaded to media systems 104 to increase the efficiency of subsequent dynamic sound adjustment. These profiles or suggestions may be associated with the sound characteristics and stored as metadata (e.g., metadata 124). Detection of sound characteristics can then result in selecting an associated profile or suggested settings which results in more quickly enhancing users'viewing experience. In some embodiments, crowdsource server(s) 128 can be located at content server 120. In some embodiments, some part of content server 120 functions can be implemented by system server 126 as well.

The system server(s) 126 may also include a physical environment model 130. In some embodiments, physical environment model 130 may be used to identify the patterns and relationship between the sound characteristics and the sound adjustments that are provided by media systems 104. Physical environment model 130 may be configured to generate the predefined profiles and/or settings that are associated with sound characteristics. Physical environment model 130 may be implemented as a machine learning model that receives the sound characteristics and the sound adjustments as inputs, and provides the predefined profiles and/or settings as output.

Patterns between the sound characteristics of the calibration sound waves and the sound adjustments can reflect the particular environment in which display device 108 and/or media device 106 are positioned. Sound characteristics can be significantly influenced by the physical environment, including factors like proximity to walls and other surfaces, and the media device of the present disclosure, working in combination with a microphone, is configured to identify necessary adjustments to accommodate the physical environment based on the sound characteristics. In some embodiments, physical environment model 130 may be utilized to assist in more quickly identifying the adjustments.

Microphone 112 of remote control 110 is configured to capture sound diagnostic waves emitted from display device 108 and/or media device 106, and identify characteristics of the sound diagnostic waves. For example, sound diagnostic waves emitted by display device 108 and/or media device 106 are received by microphone 112 in the remote control 110. Microphone 112 may be implemented as a single microphone or a plurality of microphones. Remote control 110 may be configured to identify sound characteristics of the received sound diagnostics waves. Examples of sound characteristics include but are not limited to, sound intensity, frequency, waveform, phase information, time information, and harmonic content.

The walls (or other objects) in the physical environment can play a crucial role in these sound characteristics received and recorded by microphone 112. For instance, sound intensity, or amplitude, can be affected by reflections off nearby walls. These reflections can either amplify the sound diagnostic waves (e.g., if they combine constructively with the direct sound wave from the source) or reduce it through destructive interference, creating variations in loudness throughout the room. For example, if microphone 112 is positioned near a wall, it may capture not just the direct sound from the source (i.e., display device 108 and/or media device 106) but also the reflected sound, which can alter the perceived loudness. Sound intensity may also identify distance between microphone 112 and a source. The sound intensity decreases as the distance between the sound source and microphone 112 increases.

Sound frequency is another characteristic that can be impacted by the environment. High-frequency sounds can be more easily absorbed by soft surfaces like curtains or carpets, while low-frequency sounds can reflect off walls and cause standing waves. This can lead to an asymmetric distribution of bass frequencies, which can result in certain spots in the room having an exaggerated or diminished bass response. Proximity of microphone 112 to walls can amplify this effect, especially when dealing with low frequencies.

Waveform is another characteristic that can be altered by environmental reflections. When sound waves bounce off surfaces and blend with the direct sound, they can create a complex interaction that modifies the original waveform. This results in sound characteristics that reflect a less clear or muddy sound. For example, if microphone 112 is close to a wall, the early reflections can interfere with the direct sound, making the recorded sound less defined. Sound characteristics can also be used to detect phase shifts in sound data that are caused by reflected sound waves, which occur when the reflected sound waves combine with the direct sound waves. Depending on how they interact, this can lead to constructive or destructive interference, altering the tonal balance of the sound, which can be detected in the received sound characteristics at microphone 112.

Harmonic content, which defines the timbre or quality of the sound, can also be affected by the physical environment. Hard, reflective surfaces like walls can reinforce certain harmonics, particularly in the mid and high-frequency ranges, while absorbent materials can dampen them.

In embodiments where microphone 112 is implemented as two or more microphones in remote control 110 (e.g., one microphone positioned at the top of remote control 110 and a second microphone positioned at the bottom of remote control 110), remote control 110 may be configured to identify differentiation of characteristics in the calibration sound waves received by the respective microphones, which can result in an enhanced sound profile of the physical environment.

The distance between microphones on a remote control 110 may be quite small but may still result in differences in sound characteristics received by each microphone. These differences may be used to provide additional adjustments to sound output provided by display device 108 and/or media device 106.

For example, there can be a slight difference in the time it takes for calibration sound waves to reach each microphone, especially for sounds coming from different directions. This small time difference or delay can be used to identify the directionality of the sound source and can be used to estimate the position of the sound source relative to each microphone of microphone 112. Other potential differences in characteristics may be reflected in amplitude variations and directional sensitivity.

There may be slight variations in the amplitude of the sound received by each microphone depending on the orientation and the position of reflective surfaces. For example, if one microphone is closer to a wall or a reflective surface than the other, it might capture a stronger reflection, which can affect the amplitude of the sound wave received by that microphone. Additionally, each microphones of microphone 112 may be designed with different directional sensitivities. For instance, one microphone might be more sensitive to sounds received from the front of remote control 110, while another is more sensitive to sound received from the back.

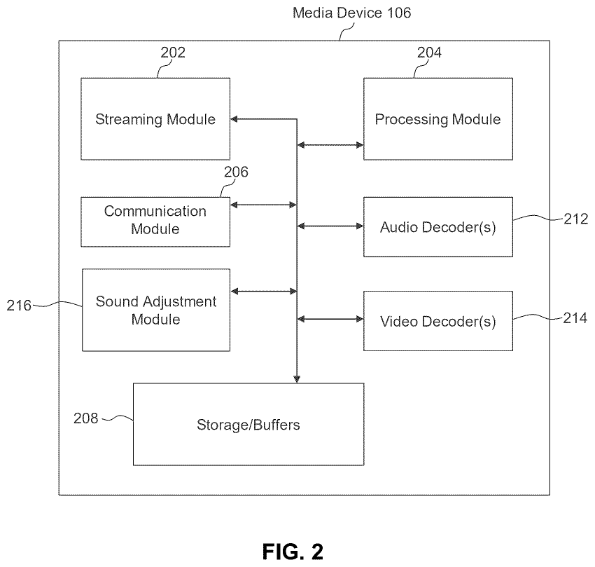

FIG. 2 illustrates a block diagram of an example media device 106, according to some embodiments. In some embodiments, media device 106 may be implemented as an internal component of display device 108 or connected as an external device via a wired connection to display device 108. When implemented as an internal component, display device 108 is configured to perform steps of the dynamic sound adjustment procedure described below with respect to the media device 106. Examples of external devices include sound bars and external speakers connectable to display device 108.

Media device 106 may include a streaming module 202, processing module 204, communication module 206, storage/buffers 208, audio decoder 212, video decoder 214, and sound adjustment module 216. Communication module 206 is configured to communicate with remote control 110, which includes receiving commands and sound data from remote control 110. Sound data provided by remote control 110 is associated with calibration sound waves emitted from the multiple speaker configuration of a display device (e.g., display device 108). Sound data includes characteristics of the calibration sound waves when received they were received by microphone 112 of remote control 110.

Streaming module 202 of the media device 106 may request selected content from the content server(s) 120 over the network 118. The content server(s) 120 may transmit the requested content to the streaming module 202. The media device 106 may transmit the received content to the display device 108 for playback to the user 132. In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

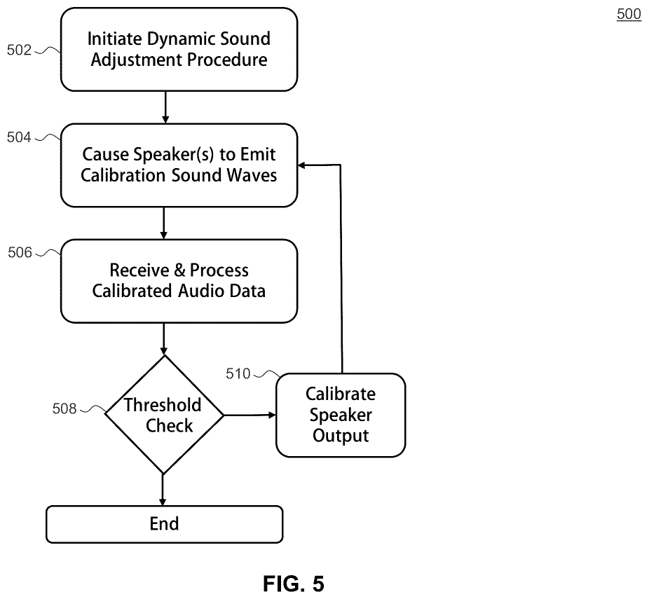

Sound adjustment module 216 can be configured to enable media device 106 to execute dynamic sound field adjustments independently of display device 108 or a network connection. Sound adjustment module 216 can be configured to process the sound data provided by remote control 110. In some embodiments, processing the sound data may include a comparison step, such as comparing one or more sound characteristics with a threshold value. For example, the sound intensity of sound data may be compared with a threshold value to determine the sound quality of calibration sound waves received by remote control 110. If the sound intensity is above the threshold, sound adjustment module 216 may determine that the sound quality is sufficient and no adjustments to the speaker sound output are necessary. If the sound intensity is below the threshold, sound adjustment module 216 may initiate the dynamic sound adjustment procedure (e.g., method 500 of FIG. 5).

In some embodiments, processing the sound data may include additional steps based on the sound characteristics of the sound data. For example, in addition to the sound intensity of the calibration sound waves received at remote control 110, sound adjustment module 216 may further identify one or more of frequency information, waveform information, phase information, and harmonic content, and generate a score or metric based on one or more of these sound characteristics. The score or metric may be generated using an algorithm or a machine learning model implemented in media device 106. Sound adjustment module 216 may then perform a comparison step of the score or metric to a threshold value for identifying the sound quality of the calibration sound waves received at remote control 110. In some embodiments, a machine learning model may trained to identify the type of processing that would provide optimized adjustments to the multi-speaker configuration of a display device. For example, the machine learning model may receive as input the sound characteristics of the sound data associated with the calibration sound waves, generate a set of adjustments to be made to the sound output of one or more speakers in the multi-speaker configuration, and test the set of adjustments against predefined threshold sound conditions. If additional adjustments are needed (e.g., the sound output from the set of adjustments falls below the predefined threshold sound conditions), then the set of adjustments may be used as additional input in the machine learning model along with the original sound characteristics and the new sound characteristics of the new sound data received from the new calibration sound waves that are emitted based on the set of adjustments.

Sound adjustment module 216 may be configured to cause calibration sound waves to be emitted from speakers (e.g., multiple speaker configuration 304 of FIG. 3) of a display device (e.g., display device 108). There may be several initiation events for causing the calibration sound waves to be emitted. Examples of initiation events may include one or any combination of turning on the media device 106, turning on the display device 108, receiving a user request to initiate the dynamic sound adjustment procedure (e.g., in response to displaying a menu screen on display device 108), and a predetermined schedule (e.g. every day, every week).

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the dynamic sound adjustment procedure may be initiated in response to an initiation event that may occur at remote control 110, media device 106, or display device 108. For example, remote control 110 may send a request to initiate the dynamic sound adjustment procedure in response to a menu screen provided by media device 106 or display device 108. In some embodiments, the request may be a selection of content (e.g., streamed from media device 106) to be displayed on display device 108. In some embodiments, the request may be a selection of a menu setting that is associated with the dynamic sound adjustment procedure.

Another example of an initiation event includes the media device 106 or display device 108 being turned on or restarted. Another example of an initiation event includes a scheduled time on a predetermined schedule (e.g., every hour, once a day, etc.). The content enhancement module 206 may generate the content enhancement protocol based on the trigger, the media content, and the one or more enhancement effects and interact with streaming module 202 to retrieve the selected media content from the content server(s) 120 over the network 118. The content server(s) 120 may transmit the requested media content to the streaming module 202. The media device 106 may transmit the received content to the display device 108 for playback.

The dynamic sound adjustment procedure is configured to detect the sound characteristics of the physical environment based on the location of a microphone (e.g., microphone 112) in relation to the speakers (e.g., multiple speaker configuration 304) outputting the sound. In some embodiments, the adjustment procedure may not need to be performed often because the physical environment does not change often, and the position of the microphone relative to the speakers (e.g., multiple speaker configuration 304) is also unlikely to change often. As one example, in a smaller living room, the position of the microphone may generally be in the same area (e.g., on a couch) relative to the speakers. As another example, in a larger living room, with more locations for the microphone to be positioned, the adjustment procedure may be configured to be initiated more often to confirm the position of the microphone relative to the speakers and the characteristics of the physical environment.

In some embodiments, the dynamic sound adjustment procedure may be configured with settings to override the adjustment, such as when multiple users are present in the physical environment. In these embodiments, performing the adjustment procedure would optimize sound output for users that are within proximity to microphone 112, but could affect the sound quality for users that are not proximate to microphone 112 since the sound output of the speakers would be adjusted most optimally for the proximate users. In such embodiments, the dynamic sound adjustment procedure may receive user input to prevent initiation of the procedure.

FIG. 3 is a block diagram of a display device 108, according to some embodiments. In some embodiments, display device 105 may be implemented with a media device 106 as an internal component of display device 108 (as depicted in FIG. 3) or connected as an external device via a wired connection to display device 108.

Display device 108 may include, in some embodiments, media device 106, multiple speaker configuration 304, display 306, communication module 310, and in some embodiments, sound adjustment module 308.

FIG. 3 depicts multiple speaker configuration 304 with an exemplary number of four speakers: first speaker 304A, second speaker 304B, third speaker 304C, and fourth speaker 304D. However, multiple speaker configuration 304 may be configured with more or less speakers than is shown. For example, multiple speaker configuration 304 may be implemented with two or three speakers. The dynamic sound adjustment procedure may be adapted to the number of speakers that are implemented within display device 108.

In some embodiments, speakers of multiple speaker configuration 304 may be implemented in various locations of display device 108. For example, first speaker 304A may be implemented as a left side-firing speaker, second speaker 304B may be implemented as a right side-firing speaker, third speaker 304C may be implemented as a bottom speaker, and fourth speaker 304D may be implemented as a back speaker (e.g., located behind display 306). In some embodiments, third speaker 304C may be implemented as a tweeter or woofer. However, multiple speaker configuration 304 is not limited to this embodiment, and may include any combination of speakers including left side-firing speaker, right side-firing speaker, a bottom speaker, and a back speaker.

In some embodiments, sound adjustment module 308 may be implemented as a component of display device 108 (instead of or in addition to sound adjustment module 216 implemented in media device 106). Sound adjustment module 308 may operate in the same manner described above with regard to sound adjustment module 216. Sound adjustment module 308 can be configured to enable display device 108 to execute dynamic sound field adjustments independently of a network connection, without having to communicate with a server or a cloud.

Sound adjustment module 308 is configured to execute the dynamic sound adjustment procedure. Sound adjustment module 308 is configured to cause speakers in multiple speaker configuration 304 to emit sound diagnostic waves as part of the dynamic sound adjustment procedure and further configured to generate adjustments to the sound output from the speakers in response to receiving audio data based on the sound diagnostic waves.

In some embodiments, the dynamic sound adjustment procedure may employ passive analysis by transmitting sound diagnostic waves may be implemented using sound from content (i.e., audible sound) provided by media device 106. That is, the dynamic sound adjustment procedure may utilize sound (e.g., dialogue, music, sound effects) from media content as the sound diagnostic waves. Sound data associated with these types of diagnostic waves may include sound intensity (volume) and frequency response (e.g., bass, treble). In these embodiments, the dynamic sound adjustment may occur whenever content is being displayed by display device 108, and in some embodiments, may allow sound adjustment module 308 to perform continuous monitoring of sound quality at the position of the microphone 112.

In some embodiments, sound adjustment module 308 may cause multiple speaker configuration 304 to emit audible sound via frequency sweeps (tones that gradually cover a range of low, mid, and high frequencies in the audible range, such as 20 Hz to 20 kHz) or specific test tones through multiple speaker configuration 304. Lower frequencies, such as below 250 Hz may be used to determine bass sound quality; mid frequencies, such as between 250 Hz and 2 kHz may be used to determine general sound quality of sound output for dialogue. Testing the range of frequencies in the audible range can allow sound adjustment module 308 to determine how different frequencies are affected by the room and received by microphone 112. Because audible sound from content can span these different frequencies, sound adjustment module 308 can output adjustments to sound characteristics of sound output to improve the audio quality for one or more of dialogue, music, or sound effects that are received by microphone 112. As noted above, the dynamic sound adjustment procedure may infer that one or more users are located proximate to microphone 112 and therefore the users will benefit from the adjustments that are made. Accordingly, sound adjustment module 308 can make adjustments to sound output of multiple speaker configuration 304 to optimize sound quality for different content types (e.g., a movie scene may have more bass, while dialogue emphasizes midrange frequencies). Advantages of using a variety of frequencies (instead of just sound from media content) enables more precise measurement about how specific frequencies are received at the location of the microphone, which allows for more specific adjustments for certain frequencies (e.g., bass, midrange, treble).

In some embodiments, the dynamic sound adjustment procedure may employ active analysis by transmitting a broader spectrum of sound diagnostic waves (i.e., beyond human hearing), which can provide advantages over using audible sound waves from media content. In these embodiments, one or more speakers of multiple speaker configuration 304 may be configured to emit ultrasonic frequencies that are still able to be captured by microphone 112 (i.e., above 20 kHz). These embodiments allow the adjustment procedure to be performed without impacting the user.

In some embodiments, sound adjustment module 308 processes sound data received from microphone 112 (e.g., via media device 106 or communication module 310). Sound data includes characteristics about the sound quality of sound diagnostic waves received at microphone 112. Sound characteristics include any combination of sound intensity, frequency, waveform information, and harmonic content.

In some embodiments, remote control 110 may be configured to associate a speaker identifier to the sound data to identify the speakers associated with sound characteristics of the sound diagnostic waves emitted by that speaker. In some embodiments, sound adjustment module 308 is configured to associate a speaker identifier to the sound data.

Sound adjustment module 308 is configured to output adjustments to multiple speaker configuration 304 based on the sound data. For example, sound data may indicate that the sound output from first speaker 304A (e.g., a left side-firing speaker) has sound intensity below a predefined threshold. Sound adjustment module 308 may then adjust the intensity (amplitude) of sound output of first speaker 304A to compensate. The dynamic sound adjustment procedure may then be repeated as needed, with adjustments to the intensity of sound output of first speaker 304A until the sound data indicates that the sound intensity of the sound diagnostic waves is above the predefined threshold. In other examples, other characteristics, such as frequency, waveform information, and harmonic content may also be used as part of the adjustment procedure to identify adjustments for each speaker, based on their respective sound data. Other sound output properties of multiple speaker configuration 304 that may be adjusted include the bass and treble, equalizer settings, balance, dynamic range, and modifications to low, mid, and high frequencies of the sound output.

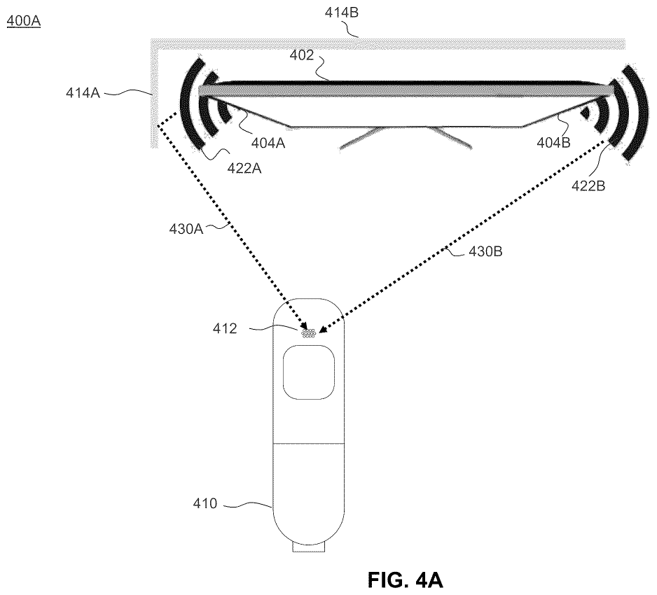

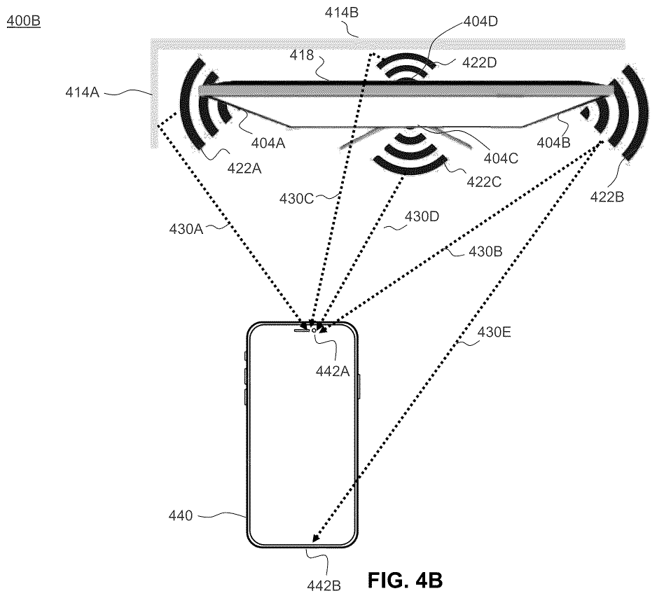

FIG. 4A depicts an example implementation 400A of a display device 402 and microphone 112 in an exemplary physical environment, according to some embodiments. In this embodiment, display device 404 is depicted with a multiple speaker configuration with left side-firing speaker 404A and right side-firing speaker 404B. Left side-firing speaker 404A is configured to emit sound diagnostic wave 422A and right side-firing speaker 404B is configured to emit sound diagnostic wave 422B as part of the dynamic sound adjustment procedure. Remote control 410 can be implemented with microphone 412, and each are exemplary embodiments of remote control 110 and microphone 412, respectively.

The physical environment of FIG. 4A may include physical objects, such as surface 414A and surface 414B. Sound diagnostic waves emitted by left side-firing speaker 404A and right side-firing speaker 404B, including sound diagnostic waves 422A and 422B, travel within physical environment include interacting with physical objects, including surface 414A and surface 414B, before arriving at microphone 112 of remote control 110.

The travel paths of sound diagnostic waves 422A and 422B, e.g., path 430A and path 430B, impact various sound characteristics of the sound diagnostic wave, such that when sound diagnostic waves 422A and 422B arrive at microphone 412, the sound characteristics of each sound diagnostic wave reflect the sound quality of the sound output at the particular location of microphone 412. Remote control 410 is configured to package the received sound data, including the sound characteristics of each received sound diagnostic wave, and transmit the sound data to display device 402 as part of the dynamic sound adjustment procedure (e.g., performed by a media device or sound adjustment module implemented within display device 402 or by a media device externally connected to display device 402).

The number of speakers in display device 402 is merely exemplary and is not limited to the number depicted in FIG. 4A. Increasing or decreasing the number of speakers impacts the dynamic sound adjustment procedure by adjusting the number of sound diagnostic waves being emitted from various speakers, which affects the number of speaker identifiers to associate with the sound data. The processing steps performed by display device 402 to identify sound data associated with each respective speaker of display device 402 takes into account the additional sound data for each additional speaker and generates additional sound adjustments as needed for each additional speaker.

FIG. 4B depicts an example implementation 400B of a display device 418 and microphones 440A, 440B in an exemplary physical environment, according to some embodiments. In this embodiment, display device 418 is depicted with a multiple speaker configuration with left side-firing speaker 404A, right side-firing speaker 404B, a bottom speaker 404C, and a backward facing speaker 404D. Left side-firing speaker 404A is configured to emit sound diagnostic wave 422A, right side-firing speaker 404B is configured to emit sound diagnostic wave 422B, bottom speaker 404C is configured to emit sound diagnostic wave 422C, and backward facing speaker 404D is configured to emit sound diagnostic wave 422D, as part of the dynamic sound adjustment procedure. Remote control 440 can be implemented with first microphone 442A and second microphone 442B, and each are exemplary embodiments of remote control 110 and microphone 412, respectively.

The physical environment of FIG. 4B may include physical objects, such as surface 410A and surface 410B. Sound diagnostic waves emitted by left side-firing speaker 404A (e.g., sound diagnostic wave 422A), right side-firing speaker 404B (e.g., sound diagnostic wave 422B), bottom speaker 404C (e.g., sound diagnostic wave 422C), and backward facing speaker 404D, travel within physical environment include interacting with physical objects, including surface 410A and surface 410B, before arriving at first microphone 442A and second microphone 442B of remote control 440.

Sound data from first microphone 442A and second microphone 442B may then be transmitted from remote control 440 to display device 418 as part of the dynamic sound adjustment procedure. In embodiments involving more than one microphone, each microphone may be configured to include a microphone identifier with the sound data to enable display device 418 to identify the sound data that is associated with each microphone.

The dynamic sound adjustment procedure may utilize sound data from multiple microphones to improve the accuracy of the sound adjustments applied to each speaker. As one example, even though the distance between the microphones on a phone is small (between the top and bottom of remote control 440), sound data received by each microphone may include a slight difference in the time it takes for sound diagnostic waves (e.g., sound diagnostic waves 430A-430E) to reach first microphone 442A versus second microphone 442B, especially for sounds coming from different directions (e.g., from reflected surfaces). The dynamic sound adjustment procedure may utilize this small inter-microphone time delay to determine sound quality of the received sound diagnostic waves, including the directionality of the speakers.

Sound data from multiple microphones may also include amplitude variations, phase differences, and directional sensitivity. For amplitude variations, depending on the orientation of remote control 440 and the position of various physical objects in the physical environment, there may be slight variations in the amplitude of the sound diagnostic waves (e.g., sound diagnostic waves 430A-430E) received by each microphone. For example, if first microphone 442A is closer to a physical object (e.g., surface 414A) than second microphone 442B, first microphone 442A might capture a stronger reflection, which can affect the perceived intensity of sound diagnostic waves.

For phase differences, the phase of the sound diagnostic waves arriving at each microphone can also vary slightly. Remote control 440 can provide these phase differences in the sound data transmitted to display device 418, and can be used in the dynamic sound adjustment procedure to infer spatial information about the environment. For directional sensitivity, in some embodiments of remote control 440, microphones may be designed with different directional sensitivities. For instance, first microphone 442A can be configured to be more sensitive to sounds coming from the front of the device, while second microphone 442B can be configured to pick up ambient noise. Providing sound data that captures the differential sensitivity can contribute to the dynamic sound adjustment procedure providing more efficient (e.g., less iterations of the adjustments) sound adjustments to the sound output from the speakers of display device 418.

### Method for Dynamic Sound Adjustment

FIG. 5 is a flowchart illustrating a method 500 for initiating a dynamic sound adjustment procedure, according to some embodiments, according to some embodiments. Method 500 can be performed by processing logic that can comprise hardware (e.g., circuitry, dedicated logic, programmable logic, microcode, etc.), software (e.g., instructions executing on a processing device), or a combination thereof. As a non-limiting example of FIGS. 1-3, one or more functions described with respect to FIG. 5 may be performed by a media device (e.g., media device 106 of FIG. 1) or a display device (e.g., display device 108 of FIG. 1). In such an embodiment, any of these components may execute code in memory to perform certain steps of method 500 of FIG. 5. While method 500 of FIG. 5 will be discussed below as being performed by certain components of multimedia environment 102, other components may store the code and therefore may execute the dynamic sound adjustment procedure by directly executing the code. Accordingly, the following discussion of content enhancement method 500 will refer to components of FIGS. 1-3 as an exemplary non-limiting embodiment. Moreover, it is to be appreciated that not all steps may be needed to perform the disclosure provided herein. Further, some of the functions may be performed simultaneously, in a different order, or by the same components than shown in FIG. 5, as will be understood by a person of ordinary skill in the art.

In step 502, display device 108 initiates the dynamic sound adjustment procedure based on detection of an initiation event. Examples of an initiation event may include user input (e.g., received from remote control 110) that requests initiating the dynamic sound adjustment procedure, a system event such as turning on or resetting media device 106 or display device 108, or a scheduled event such as performing the procedure on a predetermined interval (e.g., every day, every week). The dynamic sound adjustment procedure includes adjusting one or more sound output settings of multiple speaker configuration 304.

In embodiments where display device 108 integrates a media device 106, display device 108 may detect the initiation event. In embodiments where media device 106 is external to display device 108, media device 106 may detect the initiation event and provide instructions to the display device 108 to initiate the dynamic sound adjustment procedure.

In 504, display device 108 is configured to emit calibration sound waves based on detection of the initiation event and as part of the dynamic sound adjustment procedure. For example, display device 108 may cause a first speaker of multiple speaker configuration 304 to emit a calibration sound wave and a second speaker of multiple speaker configuration 304 to emit another calibration sound wave.

The frequencies of the calibration sound waves may be configured to span an audible and inaudible spectrum. Multiple speaker configuration 304 may include a tweeter or woofer and side-firing speakers, and calibration sound waves emitted by each speaker of multiple speaker configuration 304 may be configured at different frequencies or to be emitted at different times depending on settings of the dynamic sound adjustment procedure.

For example, multiple speaker configuration 304 may emit calibration sound waves from each speaker sequentially (e.g., first speaker 304A followed by second speaker 304B followed by third speaker 304C) or concurrently. As another example, the dynamic sound adjustment procedure may include transmitting calibration sound waves in different frequencies to detect different characteristics of the physical environment. For example, sound waves at low frequencies, e.g., between 20 Hz and 250 Hz, for analyzing bass response and range within the physical environment, mid frequencies, e.g., 250 Hx to 2 kHz, for analyzing room acoustics with regard to dialogue and music, high frequencies, e.g., 2 kHz to 20 kHz, for analyzing reflective and absorption characteristics of the physical environment, and ultrasonic frequencies that are beyond human hearing.

In some embodiments, dynamic sound adjustment procedure may rely on any combination of frequencies (and not a single frequency) for the calibration sound waves since low, mid, and high frequencies provide different advantages (and disadvantages) for providing information about the physical environment. For example, ultrasonic frequencies are beyond human hearing so calibration sound waves at this frequency can be emitted without impacting viewer experience but may provide less accurate information about the physical environment.

In some embodiments, the dynamic sound adjustment procedure may output calibration sound waves using a frequency sweep technique. This involves multiple speaker configuration 304 emitting calibration sound waves sequentially moving through a particular frequency range (e.g., from 20 Hz to 20 kHz).

The calibration sound waves emitted by multiple speaker configuration 304 are received by one or more microphones located within the physical environment. For example, microphone 412 of remote control 410 or microphones 442A, 442B of remote control 440 may receive the calibration sound waves and provide sound data for transmission back to display device 108. The sound data may include sound output characteristics associated with the calibration sound waves received by the microphone. These sound output characteristics, which include any one of sound intensity, frequency, waveform, phase, and harmonic content, may reflect the sound quality of sound output from display device 108 received at the particular location of the microphone within the physical environment.

The parameters in sound data are associated with the respective speakers that emitted the calibration sound waves. This association allows display device 108 to make adjustments to each speaker as needed based on the sound output characteristics of the sound data. For example, if sound data indicates a sound intensity below a predetermined threshold for first speaker 308A and a sound intensity above a predetermined threshold for second speaker 308B, display device 108 may adjust the sound output of first speaker 308A and second speaker 308B accordingly. Remote control 410 may be configured to transmit the sound data to display device 108. In some embodiments, remote control 410 is configured to include speaker identifiers in the sound data to assist in associating sound data with respective speakers in multiple speaker configuration 304.

In embodiments when calibration sound waves are emitted sequentially, remote control 410 may be configured to transmit the sound data in the same sequence to allow display device to identify sound data associated with each speaker of multiple speaker configuration 304.

In some embodiments, the sound data may be transmitted to display device 108 without association to any particular speaker. In these embodiments, display device 108 may be configured to identify speakers that require adjustments by analyzing the sound data.

In 506, display device 108 receives the sound data associated with the calibration sound waves emitted in 504. For example, display device 108 may receive the sound data from a remote device, such as remote control 410 or remote control 440. The sound data comprises one or more sound output characteristics associated with each of the calibration sound waves. and the second calibration sound wave.

In some embodiments, display device 108 further processes the sound data by identifying the one or more sound output characteristics—e.g., sound intensity, frequency, waveform, phase, and harmonic content - in the sound data to be used for determining the adjustments that need to be made to the sound output of multiple speaker configuration 304. Selecting one characteristic allows display device 108 to fine tune specific output of a particular parameter of speaker output. For example, display device 108 may use sound intensity in the sound data to determine whether to increase the volume of speakers.

On the other hand, selecting a combination of different characteristics, while more computationally complex, allows for more nuanced adjustments of multiple parameters of sound output. These parameters of sound output can include any combination of volume, bass and treble properties, equalizer settings, balance, dynamic range control, and frequency boosting.

In 508, display device 108 analyzes the sound data based on one or more predetermined sound characteristic threshold values, such as comparing the sound intensity indicated in the sound data to a sound intensity threshold. In some embodiments, one sound characteristic may be analyzed. In some embodiments, multiple sound characteristics may be analyzed and compared to particular thresholds. For example, one or more values for sound intensity, frequency, waveform, phase, and harmonic content indicated in the sound data may be compared to corresponding threshold values for each characteristic.

In 510, display device 108 adjusts sound output of multiple speaker configuration 304 based the result of comparing the one or more sound characteristics to one or more sound characteristic threshold values. If the sound quality indicated by the sound data is above the one or more threshold values, then the dynamic sound adjustment procedure ends. If the sound quality indicated by the sound data is below the one or more threshold values, then the dynamic sound adjustment procedure may continue. The adjustment of sound output includes increasing or decreasing values for one or more parameters of sound output from multiple speaker configuration. For example, display device 108 may adjust one or more of volume, bass and treble properties, equalizer settings, balance, dynamic range control, and frequency boosting of the sound output.

Volume of one or more speakers in multiple speaker configuration 304 may be increased or decreased based on the sound intensity in the sound data. Bass and treble properties may be increased or decreased to, for example, make the sound deeper (bass) or clearer and sharper (treble), based on the sound data associated with low and high frequency calibration sound waves. Equalizer settings can adjust different frequency bands collectively, and can be based on the sound data associated provided by frequency sweeps. Balance settings results in redistributing sound between each speaker, such as by redistributing sound between first speaker 308A and second speaker 308B. Balance settings can be helpful when adjusting for when the microphone is located off-center from display device 108, which can be indicated by, for example, the sound intensity of calibration sound waves received at the microphone. Dynamic range control adjusts the range between quietest and loudest sounds within sound output, which can allow for quieter sounds to be more audible while louder sounds are diminished. Frequency boosting can include boosting different frequencies of sound output, such as boosting midrange frequencies (and decreasing low and high frequencies) to improve midrange sounds such as dialogue and music.

In some embodiments, display device 108 may adjust sound output of multiple speaker configuration 304 without notifying the viewer or receiving any input or confirmation from the viewer. In some embodiments, display device 108 may be further configured to generate a user interface to display the dynamic sound adjustment procedure in real-time, including the steps of 504-510 described above. For example, display device 108 may be configured to display corresponding user interface screens associated with each step to inform the viewer regarding the status of the dynamic sound adjustment procedure. A user interface screen for 504 may include a graphic of display device 108 and multiple speaker configuration 304 and an animation showing when calibration sound waves are being emitted by respective speakers. As another example, a user interface screen for 508 may display the various sound statistics or a sound quality score that is generated based on the received sound data. The sound quality score may be used to provide a simple metric to the viewer to understand the sound quality at which the microphone is located within the particular room.

After adjustments in 510, the dynamic sound adjustment procedure may repeat 504-508 to test the sound quality of the sound output based on the adjusted parameters of the sound output.

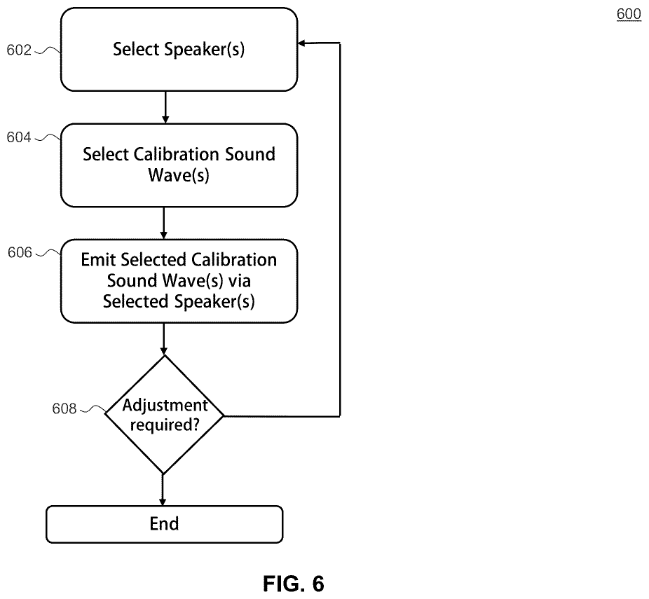

FIG. 6 is a flowchart illustrating a method 600 for emitting calibration sound waves, according to some embodiments, according to some embodiments. Method 600 can be performed by processing logic that can comprise hardware (e.g., circuitry, dedicated logic, programmable logic, microcode, etc.), software (e.g., instructions executing on a processing device), or a combination thereof. As a non-limiting example of FIGS. 1-3, one or more functions described with respect to FIG. 6 may be performed by a media device (e.g., media device 106 of FIG. 1) or a display device (e.g., display device 108 of FIG. 1). In such an embodiment, any of these components may execute code in memory to perform certain steps of method 600 of FIG. 6. While method 600 of FIG. 6 will be discussed below as being performed by certain components of multimedia environment 102, other components may store the code and therefore may execute method 600 by directly executing the code. Accordingly, the following discussion of content enhancement method 500 will refer to components of FIGS. 1-3 as an exemplary non-limiting embodiment. Moreover, it is to be appreciated that not all steps may be needed to perform the disclosure provided herein. Further, some of the functions may be performed simultaneously, in a different order, or by the same components than shown in FIG. 6, as will be understood by a person of ordinary skill in the art.

Method 600 can be performed as part of 504 in method 500 for causing speakers to emit calibration sound waves as part of the dynamic sound adjustment procedure.

In 602, display device 108 can select the speakers (e.g., of multiple speaker configuration 304) that will be part of the dynamic sound adjustment procedure. Any combination of speakers of display device 108 can be selected. In embodiments, the selection of speakers can be based on selection parameters for determining which speakers should emit calibration sound waves. Examples of selection parameters include the content being displayed by display device 108, historical information about the physical environment (e.g., stored from prior execution of the dynamic sound adjustment procedure), and the sound characteristics of the sound data received by display device 108 (e.g., from prior sound data received during prior execution of the dynamic sound adjustment procedure). In some embodiments, display device 108 can select speakers that it identifies as requiring sound adjustment. In some embodiments, display device 108 selects all speakers each time in order to adjust sound output for each speakers during each execution of the dynamic sound adjustment.

As a non-limiting example, the type of content being displayed (or selected) may determine the type of calibration sound waves that are emitted by the speakers. For example, a type of content that is tagged as having more dialogue (e.g., romantic comedy or drama) can result in display device 108 selecting speakers (e.g., tweeter) that are capable of emitting sound wave frequencies associated with dialogue are received by the microphone. As another example, a type of content is tagged as having more bass (e.g., action) can result in display device 108 selecting speakers (e.g., woofer) that are capable of emitting sound wave frequencies associated with action scenes (e.g., explosions).

In 604, display device 108 can next select the type of calibration sound waves (e.g., low, mid, high) that are emitted by the selected speakers. The type of calibration sound waves may be selected based on the selected speakers because each speaker may be limited to emitting only certain types of calibration sound waves (e.g., tweeter limited to emitting higher frequency sound waves than a woofer). As a non-limiting example, the type of content being displayed (or selected) may determine the type of calibration sound waves that are emitted by the speakers. For example, a type of content that is tagged as having more dialogue (e.g., romantic comedy or drama) can result in emitting calibration sound waves from the selected speakers for testing how sound wave frequencies associated with dialogue are received by the microphone. As another example, a type of content is tagged as having more bass (e.g., action) can result in emitting calibration sound waves from the selected speakers for testing how sound wave frequencies associated with sound effects are received. Selection of calibration sound waves is not limited to selecting one type of calibration sound wave, but can include selecting multiple calibration sound waves with different frequencies.

In 606, display device 108 causes the selected speakers from 602 and the selected frequencies from 604 to be emitted.

In 608, display device 108 determines, based on sound data received from the microphone (e.g., microphone 112 or remote control 110), whether additional adjustments need to be made to the sound output of the speakers. As noted above, adjustments to sound output can include adjusting different output parameters of the sound emitted by the speakers. Examples of these output parameters include the volume, bass and treble output, equalizer settings, balance between the speakers, frequency boosting, and dynamic range. Selection of which parameters to modify can be based on the sound data provided by the microphone. The sound data can indicate, based on the calibration sound waves emitted by each speaker, whether to increase or decrease values for each of these parameters and for which speaker. If further adjustments are needed, then the dynamic sound adjustment procedure may repeat 602-606.

### Example Computer System

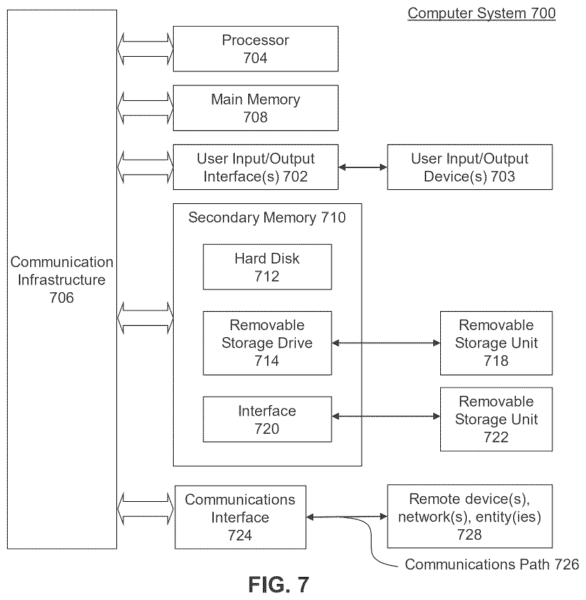

Various embodiments may be implemented, for example, using one or more well-known computer systems, such as computer system 700 shown in FIG. 7. For example, the media device 106 may be implemented using combinations or sub-combinations of computer system 700. Also or alternatively, one or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for dynamic adjustment of sound output of a multi-speaker configuration of a display device, comprising:
detecting, by the display device, an initiation event for initiating the dynamic adjustment of sound output of the multi-speaker configuration of the display device;
causing a first speaker of the multi-speaker configuration to emit a first calibration sound wave and a second speaker of the multi-speaker configuration to emit a second calibration sound wave responsive to detecting the initiation event;
receiving, by the display device from a remote device, sound data, wherein the sound data comprises a sound output characteristic associated with the first calibration sound wave and the second calibration sound wave;
analyzing the sound data based on a sound characteristic threshold value; and
adjusting sound output of at least one of the first speaker and the second speaker based on the sound output characteristic.

2. The computer-implemented method of claim 1, wherein the multi-speaker configuration comprises a plurality of side-firing speakers, and the first speaker comprises a left side-firing speaker and the second speaker comprises a right side-firing speaker.

3. The computer-implemented method of claim 1, wherein the multi-speaker configuration further comprises a side-firing speaker and at least one of a bottom speaker and a back speaker, and wherein the first speaker comprises the side-firing speaker and the second speaker comprises the at least one of the bottom speaker and the back speaker.

4. The computer-implemented method of claim 1, further comprising:
displaying, by the display device, a position confirmation screen responsive to detecting the initiation event; and
receiving, via the remote device, a confirmation instruction subsequent to displaying the position confirmation screen, wherein the confirmation instruction indicates that user input is received by the remote device, and wherein causing the first speaker to emit the first calibration sound wave and the second speaker to emit the second calibration sound wave is triggered based on the initiation event and the confirmation instruction.

5. The computer-implemented method of claim 1, wherein the initiation event comprises at least one of turning on the display device or receiving a user request.

6. The computer-implemented method of claim 1, wherein the sound characteristic threshold value comprises a sound intensity threshold and wherein the sound output characteristic comprises first intensity information for the first calibration sound wave and second intensity information for the second calibration sound wave, and wherein the analyzing the sound data comprises:
performing a first comparison of the first intensity information with the sound intensity threshold and a second comparison of the second intensity information with the sound intensity threshold, wherein adjusting the sound output of at least one of the first speaker and the second speaker comprises:
adjusting a first intensity of first sound output from the first speaker based on the first comparison; and
adjusting a second intensity of second sound output from the second speaker based on the second comparison.

7. The computer-implemented method of claim 1, wherein the display device comprises a television, and wherein the multi-speaker configuration is integrated as internal speakers of the television.

8. The computer-implemented method of claim 1, wherein the display device comprises a television connected to an external media device, wherein the multi-speaker configuration is integrated as internal speakers of the television, and wherein the external media device is configured to communicate with the remote device.

9. A display device configured to perform dynamic adjustment of sound output of a multi-speaker configuration of the display device, comprising:
a storage module;
the multi-speaker configuration comprising a first speaker and a second speaker;
at least one processor coupled to the storage module, and configured to:
detect an initiation event for initiating the dynamic adjustment of sound output of the multi-speaker configuration;
cause the first speaker to emit a first calibration sound wave and the second speaker to emit a second calibration sound wave responsive to detecting the initiation event;
receive, from a remote device, sound data, wherein the sound data comprises a sound output characteristic associated with the first calibration sound wave and the second calibration sound wave;
analyze the sound data based on a sound characteristic threshold value; and
adjust sound output of at least one of the first speaker and the second speaker based on the sound output characteristic.

10. The display device of claim 9, wherein the multi-speaker configuration comprises a plurality of side-firing speakers, and the first speaker comprises a left side-firing speaker and the second speaker comprises a right side-firing speaker.

11. The display device of claim 9, wherein the multi-speaker configuration further comprises a side-firing speaker and at least one of a bottom speaker and a back speaker, and wherein the first speaker comprises the side-firing speaker and the second speaker comprises the at least one of the bottom speaker and the back speaker.

12. The display device of claim 9, wherein the at least one processor is further configured to:
display a position confirmation screen responsive to detecting the initiation event; and
receive, via the remote device, a confirmation instruction subsequent to displaying the position confirmation screen, wherein the confirmation instruction indicates that user input is received by the remote device, and wherein causing the first speaker to emit the first calibration sound wave and the second speaker to emit the second calibration sound wave is triggered based on the initiation event and the confirmation instruction.

13. The display device of claim 9, wherein the initiation event comprises at least one of turning on the display device or receiving a user request.

14. The display device of claim 9, wherein the sound characteristic threshold value comprises a sound intensity threshold and wherein the sound output characteristic comprises first intensity information for the first calibration sound wave and second intensity information for the second calibration sound wave, and wherein in analyzing the sound data the at least one processor is further configured to:
perform a first comparison of the first intensity information with the sound intensity threshold and a second comparison of the second intensity information with the sound intensity threshold, wherein in adjusting the sound output of at least one of the first speaker and the second speaker the at least one processor is further configured to:
adjust a first intensity of first sound output from the first speaker based on the first comparison; and
adjust a second intensity of second sound output from the second speaker based on the second comparison.

15. The display device of claim 9, wherein the display device comprises a television, and wherein the multi-speaker configuration is integrated as internal speakers of the television.

16. The display device of claim 9, wherein the display device comprises a television connected to an external media device, wherein the multi-speaker configuration is integrated as internal speakers of the television, and wherein the external media device is configured to communicate with the remote device.

17. A non-transitory computer-readable medium having instructions stored thereon that, when executed by at least one computing device, cause the at least one computing device to perform operations comprising:
detecting an initiation event for initiating dynamic adjustment of sound output of a multi-speaker configuration of the at least one computing device;
causing a first speaker of the multi-speaker configuration to emit a first calibration sound wave and a second speaker of the multi-speaker configuration to emit a second calibration sound wave responsive to detecting the initiation event;
receiving, from a remote device, sound data, wherein the sound data comprises a sound output characteristic associated with the first calibration sound wave and the second calibration sound wave;
analyzing the sound data based on a sound characteristic threshold value; and
adjusting sound output of at least one of the first speaker and the second speaker based on the sound output characteristic.

18. The non-transitory computer-readable medium of claim 17, wherein the multi-speaker configuration comprises a plurality of side-firing speakers, and the first speaker comprises a left side-firing speaker and the second speaker comprises a right side-firing speaker.

19. The non-transitory computer-readable medium of claim 17, wherein the multi-speaker configuration further comprises a side-firing speaker and at least one of a bottom speaker and a back speaker, and wherein the first speaker comprises the side-firing speaker and the second speaker comprises the at least one of the bottom speaker and the back speaker.

20. The non-transitory computer-readable medium of claim 17, wherein the sound characteristic threshold value comprises a sound intensity threshold and wherein the sound output characteristic comprises first intensity information for the first calibration sound wave and second intensity information for the second calibration sound wave, and wherein in analyzing the sound data the operations further comprising:
performing a first comparison of the first intensity information with the sound intensity threshold and a second comparison of the second intensity information with the sound intensity threshold, wherein in adjusting the sound output of at least one of the first speaker and the second speaker the operations further comprising:
adjusting a first intensity of first sound output from the first speaker based on the first comparison; and
adjusting a second intensity of second sound output from the second speaker based on the second comparison.
